(19) United States
(12) Patent Application Publication
(10) Pub. No.: US 2003/0133845 A1
(43) Pub. Date: Jul. 17, 2003

(54) Identification device for explosives or other materials

(75) Inventor: Avraham Shekalim, Nesher (IL)

Correspondence Address: IP Department, Schnader Harrison Segal & Lewis, 36th Floor, 1600 Market Street, Philadelphia, PA, 19103, US

(73) Assignee: Eureka Group

(21) Appl. No.: 10/047,896

(22) Filed: Jan. 14, 2002

(51) Int. Cl. B01L 3/00

(52) U.S. Cl. 422/102; 422/99; 436/183; 73/35.14

(57) ABSTRACT

The present invention provides methods and apparatus for identifying dangerous material that has an outer shell and at least one internal unit disposed within the shell that has a sealed tube and a dynamic needle moveable relative to the shell and with a penetration end disposed adjacent the first end of the tube and a proximal end disposed within a sleeve. The sleeve surrounds the dynamic needle and is in a sealed relationship with the tube. The device also has a fixed needle affixed to the outer shell with a penetration end adjacent the second end of the tube, and a dispersal end of the fixed needle disposed within the outer shell. In operation, the fixed needle punctures the tube and the dynamic needle forces a higher pressure within the tube to evacuate its contents and thus permit testing for dangerous substances, contaminants or contraband. Preferably, the apparatus has more than one and most preferably three internal units all of which are operated by an activation handle connected to the dynamic needle and protruding through the outer shell. Most preferably, the activation handle is a slider disposed within a slot in the outer shell. In preferred embodiments, the proximal end of the dynamic needle is sealed to a distribution orifice disposed within the activation handle that connects a lumen of the dynamic needle and an interior chamber of the tube. It is preferred that the tube is comprised of glass and the sealing cap is comprised of a plastics material, and that portions of the apparatus are transparent.

### BACKGROUND OF THE INVENTION

1. Field of the Invention

The present invention relates to methods and apparatus for identifying explosives or hazardous materials that cannot be identified by conventional techniques, or to more efficiently and reliably identify such materials.

2. Brief Description of the Prior Art

There is often a necessity, for reasons of safety and security, to test packages or other objects for the presence of absence of explosives and other hazardous materials. The primary example of the need for such testing is at commercial airports, however, numerous other installations, such as bridges and tunnels, and large parcel processing centers have an ongoing need to test parcels, containers, packages and the like for the presence of dangerous or prohibited materials.

Another situation where such technology is used is finding unexploded ordnance or buried land mines. Typically, this requires the detection of selected volatile nitro-containing compounds present common explosives such as trinitrotoluene (TNT). While analytical techniques are available to detect the presence of many substances down to levels as low as parts per billion (ppb) or less, such analytical techniques generally require collecting a sample in the field, taking the sample to a laboratory, and analyzing the sample. Chemical detection devices of exquisite sensitivity have also been developed, based on the principles, for example, of mass spectrometry, ion-mobility spectrometry, or gas chromatography. Effective devices are shown, for example, in U.S. Pat. Nos. 5,200,614 and 5,491,337. Commercialized detectors that incorporate this technology typically function by initially rubbing a wipe over an article, such as a piece of luggage that is likely to carry a trace amount of a composition of interest. The wipe then is placed in an apparatus and an air stream are directed through the wipe to transport trace amounts of molecules of interest into the apparatus for detection. Such analysis requires sophisticated equipment that generally requires up to several days to obtain final results, and such analysis is therefore not generally suited to field use. Thus, present analytical techniques fail to provide any real-time information about the presence of nitro-containing organic compounds. Another category of materials that must often be detected on a real-time basis is chemical compounds used in chemical warfare such as nerve gas. The detection of these agents to allow for protection of personnel or to allow for detection of suspected production sites is important. Numerous other materials, whether hazardous, potentially weapons, contaminants or contraband are often detectable by a chemical reaction that can be performed as needed without resort to analytical instrumentation.

Much prior research has been directed to developing chemical sensors that can give more rapid feedback information. One example is U.S. Pat. No. 5,151,110 that discloses piezoelectric sensor contained within a surface acoustic wave (SAW) device or a quartz crystal microbalance (QCM) device, and a coating, such as zeolite crystals in an inorganic silica matrix, applied to the substrate to selectively sorb chemical entities of a size less than a predetermined magnitude. While such a chemical sensor is useful, it is limited to materials that physically fit within the particular pore sizes of the zeolite crystals. U.S. Pat. No. 4,860,573 describes a composite substrate intended for an apparatus for quantitative detection of, e.g., an organic component present in a gas or liquid. U.S. Pat. No. 5,418,058 describes chemical microsensors for the detection of selected organic compounds such as aromatic compounds, polyaromatic compounds, oxygen-containing organic compounds, and halogenated hydrocarbons.

However, even the improved technology of such sensors is insufficient for the volume of inspections that need to be accomplished under many of the above-described scenarios, and is further cost-prohibitive. U.S. Pat. Nos. 3,991,680 and 4,256,038 relate to methods of detecting small bombs by tagging explosive materials with a so-called “vapor taggant” which can be “sniffed” and detected by suitable equipment. The vapor taggant disclosed in U.S. Pat. No. 3,991,680 is sulfur hexafluoride (SF. ₆) absorbed in a fluoro-polymer. The vapor taggant disclosed in U.S. Pat. No. 4,256,038 is a Perfluorocarbon Tracer (“PFT”) which includes one or a plurality of the following compositions: perfluorocycloalkanes such as perfluorodimethylcyclobutane (PDCB), perfuoromethylcyclohexane (PMCH), and perfluorodimethylcyclohexane (PDCH); perfluoroaromatics such as hexafluorobenzene (HFB), octafluorotoluene (OFT), decafluorobiphenyl (DFBP), decafluoroxylene (DFX), octafluoronaphthalene (OFN), and pentafluoropyridene (PFP), perfluoroalkanes such as perfluorohexane (PFH), perfluoropentane (PFPT), and perfluorooctane (PFO), and perefluorocycloalkenes such as decafluorocyclohexene (DFCH) and octafluorocyclopentene (OFCP).

There still exists, however, a long-felt and as of yet unmet need to provide a device capable of handling and administering a chemical reaction-based test to determine if an item contains explosives or other contraband that is easy to use, has a long shelf-life, is relatively inexpensive and provides accurate, repeatable and reliable results.

### SUMMARY OF THE INVENTION

Accordingly, it has now been found that the shortcomings of the prior art are overcome by providing an apparatus for identifying dangerous material that has an outer shell and at least one internal unit disposed within the shell that has a sealed tube and a global replacement “dynamic” “sliding” needle moveable relative to the shell that has a penetration end disposed adjacent the first end of the tube and a proximal end disposed within a sleeve. The sleeve surrounds the dynamic needle and is in a sealed relationship with the tube. The device also has a fixed needle attached to the outer shell with a penetration end adjacent the second end of the tube, and a dispersal end of the fixed needle disposed within the outer shell. In operation, the fixed needle punctures the tube and the dynamic needle forces a higher pressure within the tube to evacuate its contents and thus permit testing for dangerous substances, contaminants or contraband. Preferably, the apparatus has more than one and most preferably three internal units all of which are operated by an activation handle connected to the dynamic needle and protruding through the outer shell. Most preferably, the activation handle is a slider disposed within a slot in the outer shell. In preferred embodiments, the proximal end of the dynamic needle is sealed to a distribution orifice disposed within the activation handle that connects a lumen of the dynamic needle and an interior chamber of the tube. It is preferred that the tube is comprised of glass and the sealing cap is comprised of a plastics material, and that portions of the apparatus are transparent.

The present invention also discloses methods for identifying dangerous materials by opening an outer an outer shell, placing an open end of the outer shell in contact with a substance to be tested, forcing the tube against a fixed needle affixed to the outer shell, and moving a dynamic needle relative to the shell to puncture a tube sealed at a first end and a second end, whereby the tube is evacuated of its contents by said contents passing through the fixed needle and a reaction occurs to enable the determination of he presence of a dangerous material. In preferred embodiments the step of forcing the tube against a fixed needle comprises moving an activation handle to cause an assembly containing a tube to move relative to the outer shell and most preferably, the step of moving an activation handle comprises sliding an external handle within a slot. The methods of the present invention preferably utilize the step of moving a dynamic needle relative to the shell to create a volume of relatively high pressure in fluid communication with the dynamic needle, whereby flow is established into the tube to assist in the evacuation of its contents. In a most preferred embodiment, the area of relatively high pressure in fluid communication with the dynamic needle further comprises the step of providing one or more orifices at one end of an assembly connected to the dynamic needle.

### BRIEF DESCRIPTION OF THE DRAWINGS

FIG. 1 is a perspective view of apparatus made in accordance with the present invention;

FIG. 2 is an elevation view of the apparatus shown in FIG. 1;

FIG. 3 is a cross-sectional view of the apparatus of FIG. 2 taken at line 3-3; and

FIG. 4 is a detailed cross-section of a sub-assembly of the apparatus illustrated in FIG. 3.

### DETAILED DESCRIPTION OF THE PREFERRED EMBODIMENTS

The present invention provides an apparatus that in preferred embodiments packages several different fluids separately. When these materials are in touch with unidentified material samples, a reaction such as a change of color or the like that indicates the existence or non-existence of an explosive or another material, e.g., contraband, poisons, infestations, contaminations, etc.

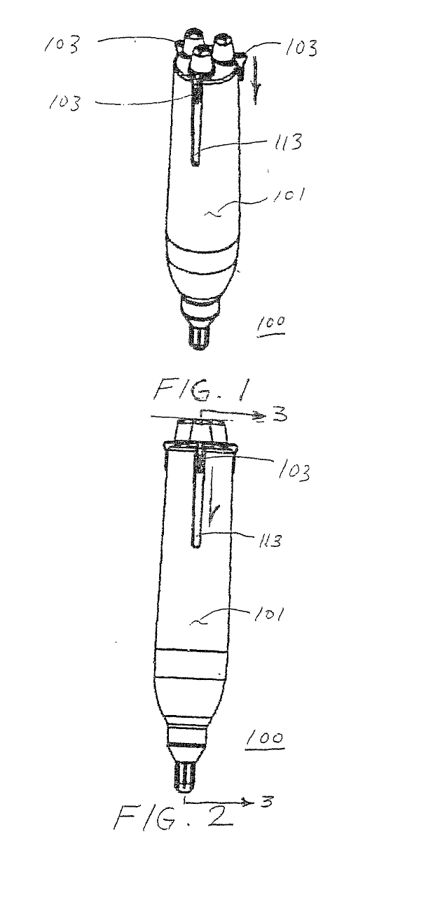

Referring now to FIG. 1, there is shown a preferred embodiment of a sampling device made in accordance with the present invention. The sampling device 100 is constructed of an outer shell 101, and a cap 102 that seals one end of the outer shell 101. An activation handle 103 protrudes from the outer shell 101 and slides in a slot 113, as explained in further detail below. A sleeve 104 functions in the manner of a piston and contains the dynamic needle assembly 105 in a sealed but moveable relationship, as further explained below. As used herein “needle” is to be construed broadly and encompasses any cannula, hollow tube or similar structure. The dynamic needle 105 is within a volume created by the sleeve that is sealed at the end opposite the dynamic needle by an O-ring 106, and the sealed end of a tube 107, which is preferably sealed by a plug 106. At the opposite end of the tube 108 is a fixed needle housing 109 that holds a fixed needle 110 in a position adjacent to a second end of the tube 107 that is also sealed by a plug 108 in the preferred embodiment shown. A cap 112 seals a bottom portion 111 of the outer shell 101.

It will be readily understood by those of skill in the art that the above-described device may be constructed of a variety of materials. Due to the nature of the materials used for detection, it will be preferred to us a tube 107 comprise of a glass material and sealed by plugs 106,108 of a plastic, rubber or composite material that is readily penetrated by the needles 105,110 yet is impervious to aging, environmental effects and otherwise proves a stable seal. The components described above in addition to the tube 107 may be made from any of a variety of plastics or metals, for example, polycarbonate or aluminum. The construction materials will vary based upon the desired cost, the material being stored in the tube, disposability and other factors.

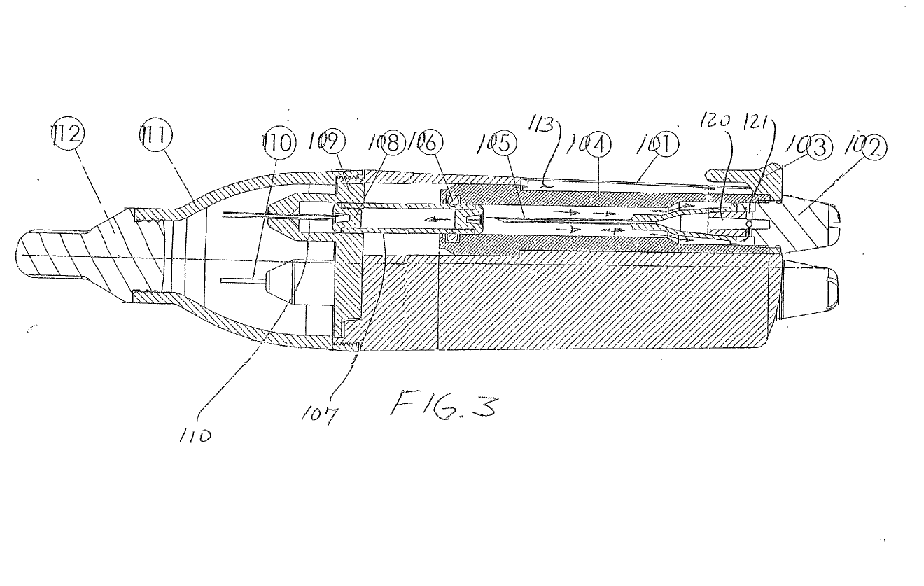

A subassembly of the device is shown in FIG. 1 is the internal unit 200. As mentioned above and seen in FIG. 1, in one preferred embodiment, three internal units 200 are disposed within a single assembly. However, assemblies similar to that shown in FIG. 1 and described above may be readily constructed with either more than three or less than three internal units. Generally, the cap 102, activation handle 103, sleeve 104, and dynamic needle 105 are mounted together into and internal unit 102, as described above. When assembled in this manner, the tube 107 has already been filled with a liquid (or gas) that is to be used in the identification or determination procedure, and has been sealed. As explained above, the tube 107 is disposed adjacent the fixed needle 110 when assembled to the device 100 such that the top end is positioned outside the piston O-ring 116, as seen in FIG. 2. This forces the tube 107 to be punched first by the fixed needle, which is very essential for the success of the process.

Referring to FIG. 2, in preferred embodiments, the outer shell 101, the fixed needle retainer 109, and the bottom portion of the outer shell 111 cover the internal assembly 200 and the other internal portions of the device 100 and are preferably assembled in such a way that will ensure that each tube 107 is centered between the fixed needle 110 and dynamic needle 105.

In a preferred embodiment, the bottom shell 111 is made out of a transparent material to enable viewing of the incoming different liquids and also viewing the result of the chemical reaction resulting from the mixture.

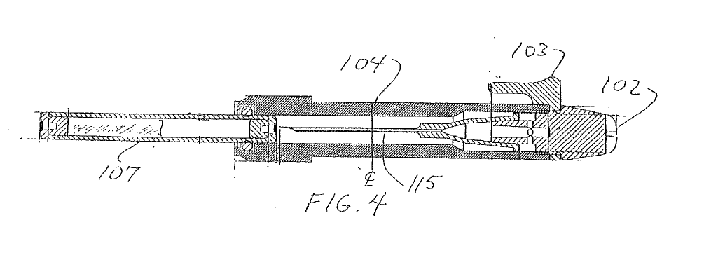

In operation, the transfer process of the liquid or gas from within the tube 107 occurs when the user depresses or displaces the activation handle 103, and in the preferred embodiment illustrated, this involves moving the handle 103 along the length of the slot 113 toward the front end of the assembly, as shown by the arrow in FIG. 1. Further details of the operation of the device are best understood with reference to FIG. 4, which illustrates that as the activation handle 103 is moved, the entire inner assembly 200 and the tube 107 move as a unit toward the fixed needle housing 109 which first forces the tube 107 against the fixed needle 110 that is positioned at the bottom of the tube, which results in penetration of the fixed needle 110 into the volume of the liquid or gas that has been secured and sealed within the tube 107. As noted above, the relative distances and position of the fixed needle 110 in relation to the dynamic needle 105 are preferably such that the fixed needle fully punctures the seal 108 prior to the seal at the opposite end being pierced. However, it will be further noted that as the activation handle 103 is moved along the slot 113, the range of motion will exceed the depth of the penetration of the fixed needle 110 and the tube 107 will “bottom out.” As further pressure is placed on the activation handle 103, the dynamic needle 105 will also puncture the tube 107 and force any materials inside the tube 107 through the fixed needle 110.

Further details of the operation of the device 100 are best understood with reference to FIG. 4. As seen in FIG. 4, as the dynamic needle 105 punctures the seal and enters the tube 107, the lumen of the dynamic needle 105 becomes a conduit in fluid communication with the interior of the tube 107. Because the movement of the dynamic needle 105 and its surrounding assembly has decreased the volume of the piston cylinder, created between the dynamic needle 105 and the O-ring 106, the gases therein increase in pressure. Providing apertures 121 in a distribution orifice 120 relieves this pressure. As shown by the arrows in FIG. 4, the gas will flow from a volume of higher pressure, through the orifices 121 and down the lumen of the fixed needle 105 into the lower pressure area inside the tube 107. As the pressure inside the tube 107 exceeds the external environment, the gas or liquid within the tube 107 will be expelled through the lumen of the dynamic needle 110. This process will continue until the activation handle reaches the limit of its travel, and in preferred embodiments, this limit will be set so as to ensure that the tube 107 is fully evacuated.

As noted above, in certain preferred embodiments, it will be desirable to proved more than one internal assembly 200, and hence more than one tube 107 that needs to be evacuated. Each tube 107 can be evacuated in whatever sequence and at whatever time is desirable from a chemical reaction standpoint by the independent motion of each activation handle 103. Conversely, the motion of two or more dynamic needles 105 can be linked by mechanical or electric actuators so that two or more tubes 107 are either emptied simultaneously, or in a predetermined sequence set by time, pressure, volume or some other parameter.

From a review of the foregoing description of the preferred embodiments of the present invention, a number of advantages will become immediately apparent to those of skill in the art. First, the design disclosed isolates that fluid or gas in a sealed tube 107 so that there is no reaction with the outside environment (e.g., oxidation) for a long period of time. The design also permits precise and relatively small amounts of fluids to be retained unmixed in separate chambers. The design of the present invention also permits the fluid to be discharged with zero dead volume remaining and the liquid or gas is expelled at a predetermined velocity without dispersal to the environment or to other surfaces for which administration is not intended. Finally, the embodiments disclosed herein are compact, safe and require little mechanical effort in use.

Although certain embodiments of the present invention have been set forth herein with particularity, it will be appreciated from the foregoing descriptions of the preferred embodiments that numerous modifications, adaptations and substitutions readily present themselves to those of skill in the art which do no not depart from the spirit of the invention disclosed herein. Therefore, in order to ascertain the true scope of the present invention, reference should be made to the appended claims.

What is claimed is:

1. Apparatus for identifying dangerous material, comprising:
an outer shell;
at least one internal unit disposed within the shell comprised of:
a tube sealed at a first end and a second end;
a dynamic needle moveable relative to the shell and having a penetration end disposed adjacent the first end of the tube and a proximal end disposed within a sleeve, wherein the sleeve surrounds the dynamic needle and is in a sealed relationship with the tube; and
a fixed needle affixed to the outer shell, having a penetration end adjacent the second end of the tube, and a dispersal end of the fixed needle disposed within the outer shell.

2. The apparatus of claim 1, wherein the internal unit further comprises:
an activation handle connected to the dynamic needle and protruding through the outer shell.

3. The apparatus of claim 2, wherein the activation handle is a slider disposed within a slot in the outer shell.

4. The apparatus of claim 2, wherein the proximal end of the dynamic needle is sealed to a distribution orifice disposed within the activation handle that connects a lumen of the dynamic needle and an interior chamber of the tube.

5. The apparatus of claim 1, comprising at least three internal units.

6. The apparatus of claim 1, wherein the outer shell further comprises a removable end cap.

7. The apparatus of claim 1, wherein the tube is comprised of a cylinder and further comprises at least one sealing cap.

8. The apparatus of claim 7, wherein the tube is comprised of glass and the sealing cap is comprised of a plastics material.

9. The apparatus of claim 1, wherein one or more portions of the apparatus are transparent.

10. Apparatus for identifying dangerous material, comprising:
an outer shell;
at least one internal unit disposed within the shell comprised of:
a tube sealed at a first end and a second end;
a dynamic needle moveable relative to the shell and having a penetration end disposed adjacent the first end of the tube and a proximal end disposed within a sleeve, wherein the sleeve surrounds the dynamic needle and is in a sealed relationship with the tube; and
a fixed needle affixed to the outer shell, having a penetration end adjacent the second end of the tube, and a dispersal end of the fixed needle disposed within the outer shell.

11. A method of identifying dangerous material, comprising the steps of opening an outer an outer shell;
placing an open end of the outer shell in contact with a substance to be tested;
forcing the tube against a fixed needle affixed to the outer shell; and
moving a dynamic needle relative to the shell to puncture a tube sealed at a first end and a second end, whereby the tube is evacuated of its contents by said contents passing through the fixed needle and a reaction occurs to enable the determination of he presence of a dangerous material.

12. The method according to claim 11, wherein the step of forcing the tube against a fixed needle comprises moving an activation handle to cause an assembly containing a tube to move relative to the outer shell

13. The method according to claim 13, wherein the step of moving an activation handle comprises sliding an external handle within a slot.

14. The method according to claim 11, wherein the step of moving a dynamic needle relative to the shell further comprises the step of creating a volume of relatively high pressure in fluid communication with the dynamic needle, whereby flow is established into the tube to assist in the evacuation of its contents.

15. The method of claim 14 wherein the step of creating a volume of relatively high pressure in fluid communication with the dynamic needle further comprises the step of providing one or more orifices at one end of an assembly connected to the dynamic needle.
